(19) United States
(12) Patent Application Publication
(10) Pub. No.: US 2003/0010793 A1
(43) Pub. Date: Jan. 16, 2003

(54) Dispensing device for a medium

(76) Inventor: Stefan Ritsche, Eigeltingen (DE)

Correspondence Address: Flynn, Thiel, Boutell & Tanis, P.C., 2026 Rambling Road, Kalamazoo, MI, 49008-1699, US

(21) Appl. No.: 10/192,503

(22) Filed: Jul. 10, 2002

(30) Foreign Application Priority Data
Jul. 11, 2001 (DE) 101 34 796.0

(51) Int. Cl. B67B 5/00

(52) U.S. Cl. 222/153.1

(57) ABSTRACT

A child-proof dispending and/or closing device which includes a dosing head that can be operated for a dispending operation, and a carrier unit which is associated with the dosing head and which can be fastened to an outlet area of a storage container for the medium. The dosing head is held in at least one inactive blocking position with the help of at least one manually releasable locking means. According to the invention, two parts of the carrier unit have tooth systems corresponding with one another, which tooth systems are held in disengagement from one another by hold-back means and can be moved temporarily into engagement with one another against the hold-back force of the hold-back means for the purpose of releasing the one part from the storage container.

### FIELD OF THE INVENTION

The invention relates to a dispensing device for a medium comprising a dosing head which can be operated for a dispensing operation, and comprising a carrier unit which is associated with the dosing head, and which can be fastened to an outlet area of a storage container for the medium, whereby the dosing head is held with the help of at least one manually releasable locking means in at least one inactive blocking position.

The invention also relates to a closing part for an outlet area of a storage container for a medium comprising a closing unit which has a closing part which can be fastened to the outlet area, and a locking part which can be moved relative to the closing part, whereby force and form-locking means are provided for the temporary achievement of an operative connection between the closing part and the locking part in at least one active direction.

### BACKGROUND OF THE INVENTION

A dispensing device for a medium is known from the DE 33 16 308 A1. The known dispensing device has a dosing head with which is associated a manually operated pump. The dosing head and the pump are fastened on a storage container by means of a carrier unit, which storage container receives the medium to be dispensed. The dosing head can be locked relative to the carrier unit and to the pump in an upper and a lower end position with the help of a locking element and corresponding recesses. The dosing head is inactive in the two locked end positions which can be manually released, namely the dosing head cannot carry out a dispensing operation.

A dispensing device for a medium is known from the WO 98/30464 which includes a closing device for an outlet area of a storage container for the medium. The closing device has a sleeve-like closing part provided with an internal thread, which closing part can be screwed onto an external thread of the outlet area of the storage container, which outlet area is designed as a neck. In order to prevent an unscrewing of the closing device from the outlet area of the storage container and to achieve in this manner a lock for the screwed-on dispensing device and for the medium content of the storage container, the closing part is surrounded by a cap-like locking part. The cap-shaped locking part is operatively connected through tooth systems in one screwing on direction on the inside of the closing part. The tooth systems are inactive in the opposite direction of rotation so that a torque transfer from the locking part to the closing part does not occur. The operative connection, that is the tooth system between locking part and closing part occurs exclusively in the screw-on direction and thus in the fastening direction of the closing part. Thus a loosening of the closing part is not possible when the locking part is mounted. This is designed to prevent, with a simple unscrewing of the closing device, an unauthorized access to the content of the storage container.

The purpose of the invention is to provide a dispensing device and a closing device of the respective type as mentioned in the beginning, which prevents an unauthorized access to the content of the storage container, in particular for children, yet enables a release of the dispensing device or of the closing device from the storage container.

This purpose is attained for the dispensing device by holding a closing part of the carrier unit on the outlet area by means of a lock, which lock prevents a release of the closing part from the outlet area of the storage container, and by providing a means for unlocking the lock. The dispensing device is designed child-proof in a particularly advantageous manner by the solution of the invention. On the one hand, an unauthorized operation of the dosing head is not possible because of the manually releasable locking means. On the other hand, an unauthorized removal of the entire dispensing device from the storage container is also prevented since the closing part is blocked by the lock. Both the dosing head and also the carrier unit serving as the closing device are thus designed child-proof. The closing part of the carrier unit, which closing part can be fastened on the outlet area of the storage container, can be fixed on the outlet area preferably via a screw connection. In the same manner, it is possible to provide other types of releasable connections between the closing part and the outlet area of the storage container. The outlet area is preferably designed as a container neck. Yet when necessary it is possible to release the closing part from the storage container. The means to take out of action the lock are provided for this purpose. Unblocking means are preferably provided as the means for unlocking the lock, which unblocking means are kept inoperative during the normal operation of the dispensing device. Hold-back means are preferably provided for this purpose. Force or form-locking means can be provided advantageously as an unblocking means, which form-locking means are provided on one surface of the closing part and on an other opposing surface of the movable part of the carrier unit. The at least one manually releasable locking means for the temporary blocking of the dosing head can be released by a single-handed operation or preferably by a two-handed operation consisting of one or several steps. At least one manually releasable locking means is particularly advantageously combined with an additional blocking mechanism for the dosing head.

The carrier unit has in a further embodiment of the invention a locking part which is movable relative to the storage container, and the closing part and the locking part have force or form-locking means, in particular tooth systems, which correspond with one another, and which are held in disengagement from one another by hold-back means, and can be moved temporarily into engagement with one another for a release of the closing part from the storage container against the hold. back force of the hold-back means. The mobility of the locking part relative to the closing part can occur through elastic deformability of the locking part and/or through axial or radial movements of at least one section of the locking part relative to the closing part. The axial or radial movements refer to a center longitudinal axis of the dispensing device. The locking part is preferably designed like a sleeve or cap and covers the closing part from outside in order to prevent access to the closing part. The force or form-locking means can be arranged distributed over the entire periphery of the two parts or can be provided only in specific section areas of the periphery. Spring means are preferably provided as the hold-back means, which spring means apply a suitable return action onto the locking part. It is also possible to provide elastically deformable areas of the locking part as the hold-back means, which areas are under tension in the respective deformed state and thus, when the load onto the locking part is removed, return same again into its initial position.

The force or form-locking means are in a further embodiment of the invention arranged in such a manner on oppositely lying surface sections of the two parts so that the force or form-locking means can be moved into engagement with one another through a relative axial movement of the two parts. This embodiment has the advantage, compared with a radial engagement, that the structural width of the dispensing device is not influenced by this so that the present embodiment can have smaller width or depth dimensions than a comparable design with a radial engagement possibility.

Elastically flexible support elements are in a further embodiment of the invention provided as the holdback means on the one part, which support elements are supported on the other part. The elastically deformable support elements are preferably provided on the locking part and are supported on the closing part. However, it is possible in the same manner to provide the elastically deformable support element on the closing part and to support these on the locking part.

The at least one locking means is in a further embodiment of the invention movably arranged between an operating position blocking the dosing head and a release position releasing the dosing head. The locking means can be movably arranged in various ways. It is advantageous to mechanically design the locking means as a slide, as a lever, as a plug element or in any other manner. The mobility can also be caused by an elastic deformability of the locking means. The at least one locking means can be arranged on the locking part or on the dosing head.

At least one locking element is arranged on the carrier unit as the locking means in a further embodiment of the invention, with which is associated at least one corresponding cam-receiving means on the dosing head. A form locking for locking the dosing head is thus achievable with simple means. Preferably at least two locking elements are provided on oppositely lying sides of the dosing head and a corresponding number of locking recesses on the dosing head.

The locking element is in a further embodiment of the invention arranged in one piece on the locking part and can be elastically flexibly moved. The locking element is preferably formed in one piece on the locking part and is elastically movable due to suitable slots or recesses. The one-piece arrangement of the at least one locking element on the locking part reduces the number of needed structural parts for the dispending device which guarantees a less expensive manufacturing ability.

Blocking means are provided for the dosing head in a further embodiment of the invention, which blocking means can be unlocked by at least one travel step of the dosing head in order to free the dosing head for a dispensing operation.

The basic purpose of the invention is attained for the closing device in such a manner that the force or form-locking means are held in disengagement by hold-back means and can be moved into engagement with one another by a relative axial movement of the locking part relative to the closing part against the hold-back force of the hold-back means. The same advantages result for the closing device as for the earlier described combined embodiment in which, besides the child-proof lock, a child-proof dosing-head operation is also provided. Therefore reference is additionally made to the earlier description.

### BRIEF DESCRIPTION OF THE DRAWINGS

Further advantages and characteristics of the invention result from the claims and from the following description of preferred exemplary embodiments of the invention which are illustrated in the drawings, in which:

FIG. 1 shows perspectively an exploded illustration of one embodiment of a dispensing device of the invention;

FIG. 2 is a perspective cross-sectional illustration of an enlarged section of the dispensing device according to FIG. 1;

FIG. 3 is a half cross-sectional view of a locking part of the carrier unit of the dispensing device according to FIG. 1;

FIG. 4 is a cross-sectional illustration of the locking part according to FIG. 3 in a cross-sectional plane intersecting the center longitudinal axis and which is perpendicular to the drawing plane according to FIG. 3;

FIG. 5 is a top view of the locking part according to FIGS. 3 and 4;

FIG. 6 illustrates a section of the locking part according to FIG. 5 along the cross-sectional line VI-VI in FIG. 5;

FIG. 7 is a view from below of the locking part according to FIGS. 3 to 5;

FIG. 8 is an enlarged illustration of a cross section of the locking part of the dispensing device according to FIG. 1 along the cross-sectional line VIII-VIII in FIG. 9;

FIG. 9 is a top view of one half of the rotation-symmetrical locking part according to FIGS. 1 and 8;

FIG. 10 is a cross-sectional view of the locking part according to FIG. 9;

FIG. 11 illustrates the dosing head of the dispensing device according to FIG. 1;

FIG. 12 illustrates schematically in cross section an embodiment of a locking part secured on a storage container for a dispensing device of the invention;

FIG. 13 is a half cross-sectional view of a further embodiment of a dispensing device of the invention; and

FIG. 14 is also a half cross-sectional view of a further embodiment of a dispensing device of the invention similar to FIG. 13.

### DETAILED DESCRIPTION

A dispensing device for a medium, preferably a product to be used for the treatment of human skin, which produce can be dosed, sprayed or dispensed in any other manner, has a manually operable pump 1 which is connected to a dosing head 2 at an outlet end. The pump 1 can be inserted into a storage container, which is not illustrated in detail. The pump 1 and the dosing head 2 can be secured to an outlet area of the storage container by means of a carrier unit 3, 4. The carrier unit 3, 4 is designed in two parts; it has a closing part 3 which can be mounted onto the outlet area of the storage container, and a locking part 4 which covers the closing part 3 sleeve-like on the outside. The closing part 3 has an internal thread 11 which can be screwed onto a corresponding external thread of the outlet area of the storage container. This guarantees the secure fastening of the closing part 3 on the storage container.

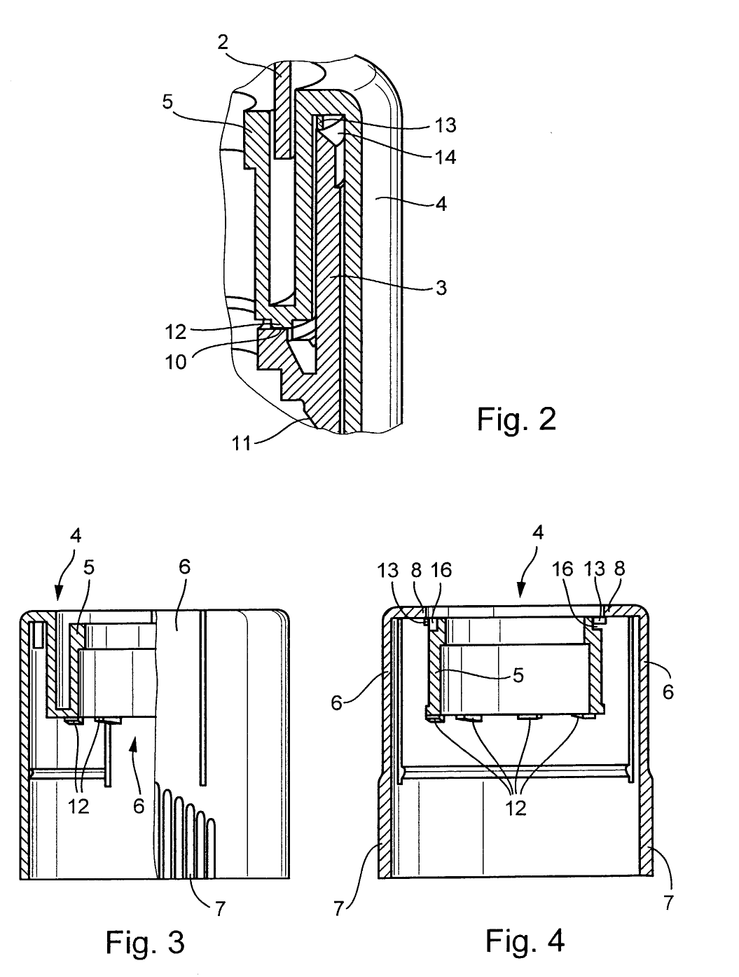

The locking part 4 can be mounted coaxially with respect to a center longitudinal axis of the pump 1 on the closing part 3, whereby an outer skirt of the locking part 4 fully covers the closing part 3 over its entire height. The locking part 4 has, besides the outer skirt, an annular flange 5 which lies within, and which is connected at its lower end through an annular shoulder (not illustrated in detail) in one piece to the outer skirt. The cross-sectional illustrations according to FIGS. 2 to 4 show the profile of the locking part 4 including the annular flange 5. An upwardly open annular gap is created between the annular flange 5 and the annular profile section of the locking part 4, which annular profile section lies farther on the outside, and into which annular gap is operatively received a wall of the dosing head 2.

The locking part 4 can be rotated relative to the closing part 3 about the center longitudinal axis. The dosing head 2 can be locked by two locking means in the form of two locking tabs 6 on the oppositely lying sides of the locking part 4 in a blocking position, in which the dosing head cannot be operated. The oppositely lying locking tabs 6, which are approximately inwardly curved through a right angle at their respective upper edges analogous to the upper annular edge of the outer skirt of the locking part, each have for this purpose in the area of their inner front edge a locking element in the form of a locking cam 8, with each of which is associated a corresponding locking recess 9 in the dosing head 2. The two locking tabs 6 are integrated in one piece with the outer skirt of the locking part 4, and are elastically movable due to two longitudinal slots provided at their two longitudinal sides, which are parallel to one another and are upwardly open. The elastic mobility is achieved by the choice of material for the locking part 4. A suitable material is a plastic which can be elastically deformed within certain limits, preferably a thermoplastic. A gripping surface 7 in the form of a ribbing is provided spaced below each locking tab 6, which ribbing continues to the lower edge of the locking part 4.

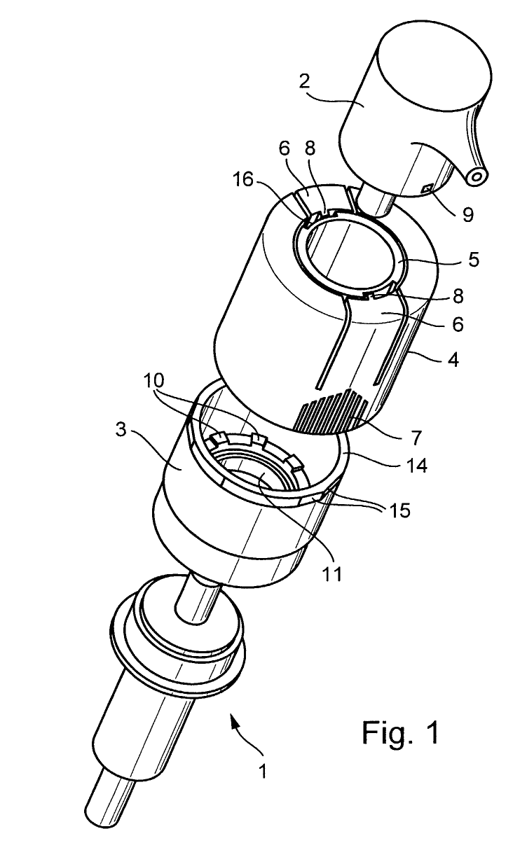

As can be recognized by looking at FIG. 1 or also FIG. 10, the closing part 3 has an annular shoulder 17 in its outer circumference, starting from which shoulder the closing part 3 has in its lower section an outer circumference with a reduced diameter. This annular shoulder 17 is in the mounted state of the locking part 4 on the closing part 3 approximately at the level of the lower end areas of the longitudinal slots for each locking tab 6, and thus approximately at the level of the upper end area of the gripping surfaces 7. With the graduation of the outer circumference of the closing part 3 in the area of the annular shoulder 17, a lever action onto the locking tabs 6 is achieved when pressure is applied to the gripping surfaces 7 since the outer skirt of the locking part 4 can be pressed inwardly toward the closing part 3 in the area of the gripping surfaces 7, thus causing the transition area between the gripping surfaces 7 and the locking tab 6 in the area of the annular shoulder 17 to rest on the closing part 3. A pivot axis for the locking tab 6 is thus created in the area of the annular shoulder 17. Thus a lever action results in that when the respective gripping surface 7 is pressed inwardly the associated locking tab 6 is pivoted outwardly, which causes the respective locking cam 8 to disengage from the corresponding locking recess in the dosing head 2. As soon as the dosing head 2 has been released, the dosing head 2 is rotated to effect a transfer to the operating position counterclockwise, viewed in a top view of the dosing head 2, until a stop is reached. Thus, simultaneously with the compressing of the outer skirt of the locking part 4 in the area of the gripping surfaces 7, the dosing head 2 must be rotated in order to prevent a renewed engagement of the locking cams 8 in the locking recess 9. A further locking geometry 16, 15 is associated as a blocking means with the dosing head 2. The dosing head 2 is initially rotated counterclockwise to stop for unlocking of this blocking geometry. The operating position of the dosing head 2 is then achieved here, in which operating position the dosing head 2 can be pressed downwardly to effect a dispensing operation. A tooth system 15 at an upper edge area of the closing part 3, which tooth system is part of the blocking geometry, prevents the locking part 4 from rotating along when the dosing head 2 is turned back.

The tooth system 15 of the blocking geometry is designed such that a force transfer between locking part 4 and closing part 3 occurs exclusively in the fastening direction of the screw thread of the closing part 3. Whereas in the release direction, the locking part 4 turns relative to the closing part 3.

Due to the fact that the locking part 4 as a hasp prevents a direct access to the closing part 3, it is basically not possible to remove the closing part 3 and thus the carrier unit and the entire dispensing device from the storage container. However, in order to still yet guarantee a release of the dispensing device fastened on the storage container, tooth systems 10, 12 are provided between the locking part 4 and the closing part 3, which tooth systems are disengaged by means of hold-back means 18 during the normal operation of the dispensing device, and can engage one another merely through force. The tooth systems 10, 12 are thereby designed such that they form-lockingly engage one another in every case in loosening direction, namely in unscrewing direction. The tooth systems in the illustrated exemplary embodiment engage one another also in the opposite direction as soon as they have been brought into engagement. Thus, a renewed screwing of the closing part 3 onto the storage container or a different storage container could also take place.

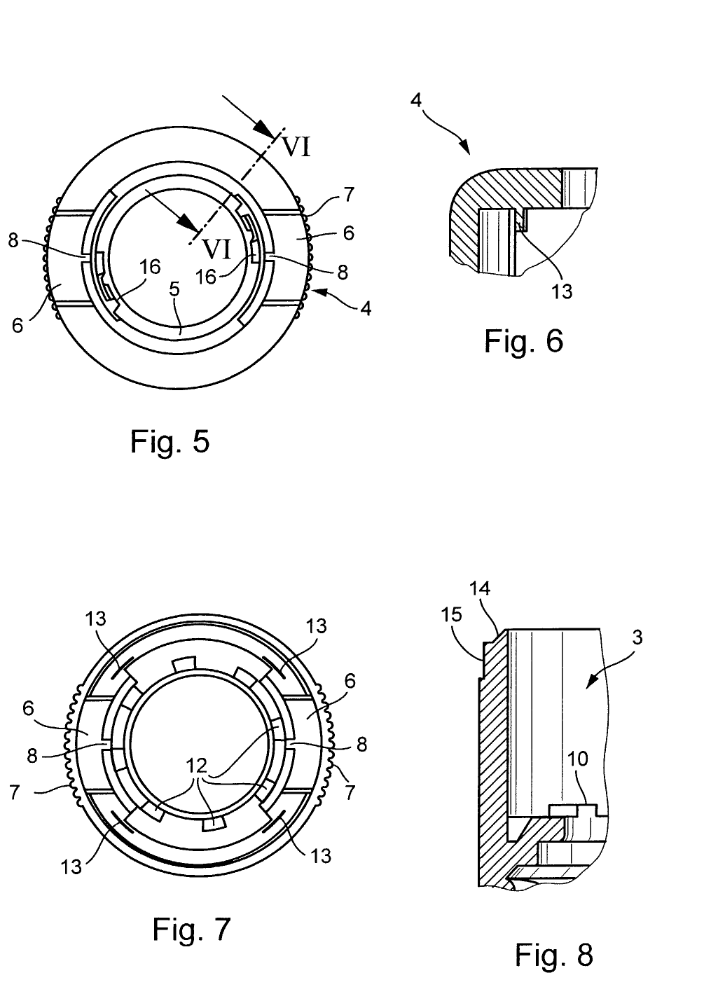

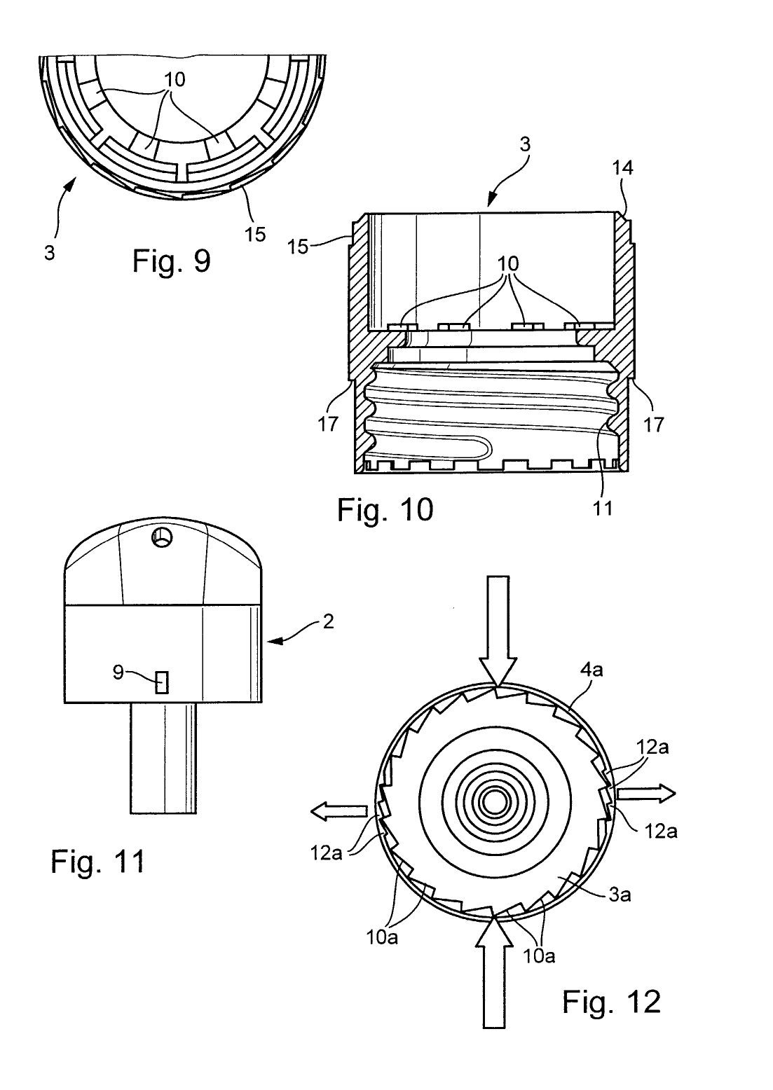

These tooth systems, which serve as a force or form-locking means for a loosening of the locked lock, must not necessarily be associated with the locking device of the dispensing device for media, as this is the case in the exemplary embodiment illustrated in FIGS. 1 to 11. It is also possible to provide such a locking device according to a not illustrated exemplary embodiment of the invention as a child-proof lock of a storage container without additional dispensing function.

The tooth systems 10, 12 can engage one another in the exemplary embodiment according to FIGS. 1 to 10 through an axial stroke, that is through a relative axial movement between the locking part 4 and the closing part 3. In order to achieve during the normal operation of the dispensing device a spacing between the tooth systems 10, 12, hold-back means in the form of elastically flexible support elements 18 are provided. These support elements 18 are designed as spring webs which project in one piece downwardly from the upper annular edge of the locking part 4, which annular edge is curved inwardly through a right angle. A total of four spring webs 18 are provided in the illustrated exemplary embodiment (see FIG. 7), which spring webs 18 are arranged evenly distributed over the periphery of the annular edge. The spring webs 18 are supported on an annular incline 14 of the upper edge area of the closing part 3, which annular incline 14 forms a conical annular surface. As soon as an axial load is manually applied downwardly, namely toward the closing part and toward the storage container onto the locking part 4, the spring webs 18 are pressed outwardly along the conical annular surface 14 and are initially tensioned. The tooth system cams 12 of the locking part 4 abut on the associated tooth-system base between the tooth-system cams 10 of the closing part 3, which causes upon the application of a torque onto the locking part 4 a form/force-locking transfer of a suitable unscrewing torque onto the closing part 3. As soon as the axial pressure load onto the locking part 4 has been removed, the spring webs 18 return again into their non-stressed initial position, which causes the locking part to be shifted automatically axially upwardly. The tooth systems 10, 12 disengage in this manner. An unscrewing of the closing part 3 is not possible in this position.

A further exemplary embodiment of the invention, as it is indicated in FIG. 12, enables a locking of the closing part on the storage container and yet when needed an unscrewing. A tooth-system ring 3a is for this purpose non-releasably connected to the outlet area of the storage container. The illustrated outer sleeve 4a, which surrounds the tooth-system ring 3a, is part of the closing part. As long as the internal tooth system 12a of the outer sleeve engages the teeth 10a of the tooth-system ring 3a, a loosening of the closing part from the outlet area of the storage container is not possible. A part of the outer sleeve is elastically deformed in the area of the internal tooth system 12a through a pressure load in the area of the large arrows onto the tooth-system ring 3a, which causes the internal tooth system 12a to disengage from the teeth 10a of the tooth-system ring 3a. A loosening of the closing part from the storage container is now possible.

An unscrewing moment onto a closing part 3a lying on the inside is in an exemplary embodiment similar to FIG. 12 not applied through axial pressure onto the locking part 4a but rather through radial pressure onto an outer sleeve of the locking part 4a. The tooth systems 12 are thereby in contrast to the illustration according to FIG. 12 in the non-deformed state of the locking part 4a disengaged from the tooth systems 10a of the closing part 3a, which tooth systems 10a lie on the inside. Merely through a pressure load at the level of the outer tooth systems 12a inwardly will the tooth systems 10a and 12a come into contact with one another and enable an unscrewing of the closing part 3a from the storage container.

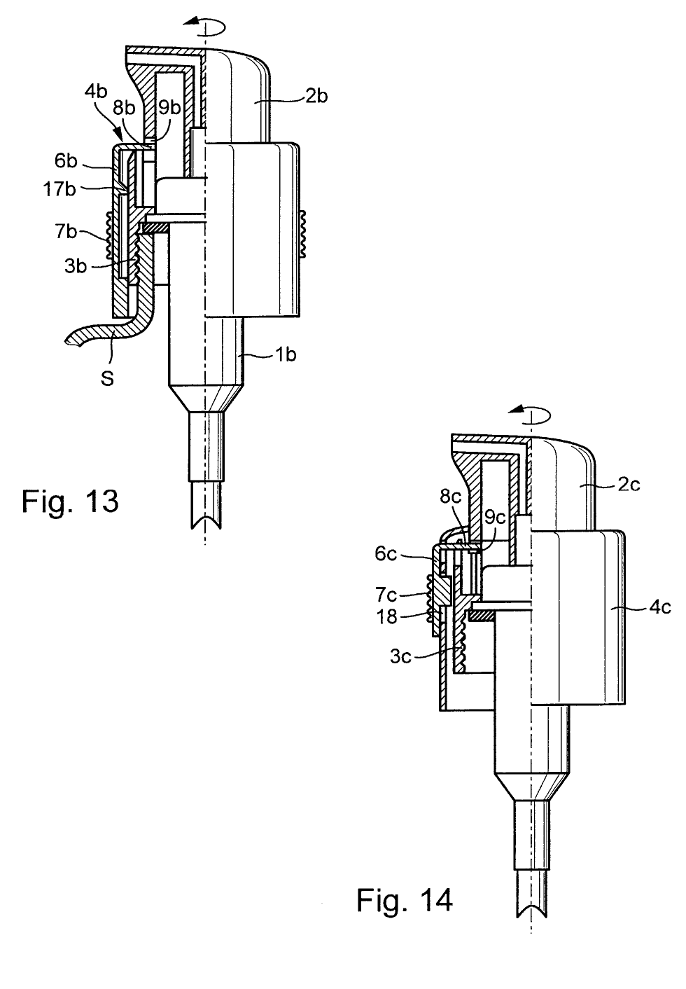

The dispensing device in the exemplary embodiment according to FIG. 13 corresponds essentially with the dispensing device described earlier in connection with FIGS. 1 to 10. The locking means for blocking of the dosing head 2b are also designed lever-shaped. The pivot axis of the lever formed between the locking tab 6b and the gripping surface 7b is in the illustrated exemplary embodiment achieved by a support cam 17b, which is supported on an outwardly facing surface of the closing part 3b lying inside of the locking part 4b. Otherwise the operation corresponds with the earlier described exemplary embodiment. For this reason the same reference numerals but with the added letter b have been utilized.

The locking means for blocking of the dosing head 2b is designed in the exemplary embodiment according to FIG. 14 as a slide element 6c, which has a gripping surface 7c. In order to achieve a suitable mobility of the slide element 6c relative to the outer sleeve 4c, an inclined ramp-like slot 18 is provided in the outer sleeve of the locking part 4c. The ramp-like slot 18 is designed such that the respectively desired blocking or release of the dosing head 2c is accomplished. It must be guaranteed at the same time that the slide element 6c cannot be transferred into the release position by a simple pressing down of the dosing head 2c, in which release position the dosing head 2c can be rotated.

What is claimed is:

1. A dispensing device for a medium comprising a dosing head which can be operated for a dispensing operation, and comprising a carrier unit which is associated with the dosing head and which can be fastened to an outlet area of the storage container for the medium, whereby the dosing head is held with the help of at least one manually releasable locking means in at least one inactive blocking position, whereby a closing part of the carrier unit is held on the outlet area by means of a lock which prevents a loosening of the closing part from the outlet area of the storage container, wherein means are provided for unlocking the lock.

2. The dispensing device according to claim 1, wherein the carrier unit has a locking part which is movable relative to the storage container, and wherein the closing part and the locking part have force or form-locking means, in particular tooth systems which correspond with one another and which are held in disengagement from one another by hold-back means, and can be moved temporarily into engagement with one another for a release of the closing part from the storage container against the hold-back force of the hold-back means.

3. The dispending device according to claim 2, wherein the force or form-locking means are arranged in such a manner on oppositely lying surface sections of the two parts so that the force or form-locking means can be moved into engagement with one another through a relative axial movement of the two parts.

4. The dispensing device according to claim 2, wherein elastically flexible support elements are provided as hold-back means on the one part, which support elements are supported on the other part.

5. The dispensing device according to claim 1, wherein at least the one locking means is movably arranged between an operating position blocking the dosing head and a release position releasing the dosing head.

6. The dispensing device according to claim 1, wherein at least one locking element is arranged as the locking means on the carrier unit, with which locking element is associated at least one corresponding cam-receiving means on the dosing head.

7. The dispensing device according to claim 6, wherein at least one locking element is arranged in the locking part of the carrier unit.

8. The dispensing device according to claim 7, wherein the locking element is arranged in one piece on the locking part and can be elastically flexibly moved.

9. The dispensing device according to claim 1, wherein in addition to the at least one locking means blocking means are provided for the dosing head which can be unlocked by at least one travel step of the dosing head in order to free the dosing head for a dispensing operation.

10. A closing device for an outlet area of a storage container for a medium comprising a closing unit which has a closing part which can be fastened to the outlet area, and a locking part which can be moved relative to the closing part, whereby force or form-locking means are provided for the temporary achievement of an operative connection between the closing part and the locking part in at least one active direction, wherein the force or form-locking means are held in disengagement by the hold-back means and can be moved into engagement with one another by an axial movement of the locking part relative to the closing part against the hold-back force of the hold-back means.
